(19) United States
(12) Patent Application Publication
(10) Pub. No.: US 2008/0257185 A1
(43) Pub. Date: Oct. 23, 2008

(54) Method for Producing Flexographic Printing forms and Appropriate Flexographic Printing Element

(75) Inventors: Armin Becker, Grossniedesheim (DE); Uwe Stebani, Floersheim-Dalsheim (DE); Gernot Dietz, Eisenberg (DE); Volker Jansen, Leonberg (DE)

Correspondence Address: CONNOLLY BOVE LODGE & HUTZ, LLP, P O BOX 2207, WILMINGTON, DE, 19899, US

(73) Assignee: FLINT GROUP GERMANY GMBH, Stuttgart (DE)

(21) Appl. No.: 11/720,301

(22) PCT Filed: Nov. 23, 2005
(86) PCT No.: PCT/EP2005/012524

§ 371 Date: May 9, 2008

(30) Foreign Application Priority Data
Nov. 26, 2004 (DE) 10 2004 057 293.3

(51) Int. Cl. B41N 1/00

(52) U.S. Cl. 101/401.1

(57) ABSTRACT

Process for the production of flexographic printing plates, in which the drying is carried out substantially using radiation, and flexographic printing element particularly suitable for carrying out the process.

The invention relates to a process for the production of flexographic printing plates by imagewise exposure of a flexographic printing element, washing out and drying, in which the drying is carried out substantially with the aid of radiation. The invention furthermore relates to a flexographic printing element particularly suitable for carrying out the process.

For the production of flexographic printing plates, first a photopolymerizable flexographic printing element can be exposed to radiation through a suitable, photographically or digitally produced mask. Thereafter, the unexposed parts, i.e. those which have remained uncrosslinked, are removed. This can be effected, for example, with the aid of suitable solvents or solvent mixtures. The exposed, crosslinked parts are not dissolved in the course of the washout but swell in the washout agent. Before use for printing, the flexographic printing plate must therefore be carefully dried again.

The drying is effected as a rule at about 65° C. in through-circulation driers. Through-circulation driers are commercially available. Here, the flexographic printing plate Is dried in a heated air stream. Depending on the plate thickness, the drying time in this conventional method of drying is from 2 to 4 hours. The drying is as a rule therefore the most time-consuming step in the production of flexographic printing plates. This prevents careful processing of print jobs by means of the flexographic printing technique.

The substrate in the case of a flexographic printing plate usually consists of a PET film. In the case of such flexographic printing plates, it is therefore not possible arbitrarily to increase the temperature for accelerating the drying, because otherwise the PET film may become distorted and the printing plate will thus become unusable. WO 03/14831 has proposed using a metallic substrate and only a thin relief layer for flexographic printing plates in newspaper printing, and effecting drying at from 105 to 160° C. However, such flexographic printing plates are as a rule not suitable for other print media.

It is known that dyes can be added to the relief layers of flexographic printing plates. These may be in particular dyes which absorb substantially in the spectral range of 300400 nm. Examples of such dyes are disclosed in EP-A 553 662. The addition of these absorbers results in absorption of the light scattered into the nonimage parts, and polymerization in these parts is thus suppressed. Consequently, the shadow well depths of the negative elements remain open and the exposure latitude increases

Also frequently used are dyes which change their color on exposure to actinic light, resulting in a color change in the exposed parts of the printing plate. Reference may be made to EP-A 1 251 400 by way of example Finally, dyes are also used for aesthetic purposes.

It was an object of the invention to provide an improved process for the production of flexographic printing plates, and starting materials suitable for this purpose, in which the speed of the drying step is substantially increased.

Accordingly, a process for the production of flexographic printing plates was found, in which the starting material used is a photopolymerizable flexographic printing element which at least comprises, arranged one on top of the other,

a dimensionally stable substrates

at least one photopolymerizable, relief-forming layer, at least comprising an elastomeric binder, ethylenically unsaturated monomers, photoinitiator and a dye,

the process comprising at least the following steps:

(a) imagewise exposure of the photopolymerizable, relief-forming layer by means of actinic radiation,

(b) washing out of the unpolymerized parts by means of a washout agent,

(c) drying of the washed-out printing plate,

the drying substantially being carried out using radiation in the VIS/NIR range and the differentiation factor (DF) of the dye

$$D F = \frac{\begin{matrix}Maximum value of the absorption \\ in the range from 450 to 1000 nm\end{matrix}}{\begin{matrix}Maximum value of the absorption \\ in the range from 300 to 400 nm\end{matrix}}$$

being greater than 1.

Furthermore, a photopolymerizable flexographic printing element was found, which at least comprises, arranged one on top of the other,

a dimensionally stable substrate,

at least one photopolymerizable, relief-forming layer, at least comprising an elastomeric binder, ethylenically unsaturated monomers, photoinitiator and a dye,

the differentiation factor (DF) of the dye

$$D F = \frac{\begin{matrix}Maximum value of the absorption \\ in the range from 450 to 1000 nm\end{matrix}}{\begin{matrix}Maximum value of the absorption \\ in the range from 300 to 400 nm\end{matrix}}$$

being greater than 1, and the amount of the dye being from 0.005 to 2% by weight, based on the amount of all components of the layer.

Regarding the Invention, the following may be stated specifically.

Examples of suitable dimensionally stable substrates for the photopolymerizable flexographic printing elements used as starting materials for the process are sheets, films and conical and cylindrical sleeves comprising metals, such as steel, aluminum, copper or nickel, or comprising polymeric materials, such as, for example, polyethylene terephthalate (PET), polyethylene naphthalate (PEN), polybutylene terephthalate, polyamide, polycarbonate. If appropriate also woven fabrics and nonwovens, such as woven glass fiber fabrics, and composite materials, for example comprising glass fibers and plastics.

Flexographic printing elements whose substrates consist of films of polymeric materials, in particular films of polyethylene terephthalate (PET), polyethylene naphthalate (PEN) or polybutylene terephthalate can preferably be used for the process. Such films usually have a thickness of from 100 μm to 250 μm. PET films are particularly preferred.

The flexographic printing element furthermore comprises at least one photopolymerizable, relief-forming layer. The photopolymerizable, relief-forming layer can be applied directly to the substrate. However, other layers, such as, for example, adhesion-promoting layers and/or resilient lower layers may also be present between the substrate and the relief-forming layer.

The photopolymerizable relief-forming layer comprises at least one elastomeric binder, ethylenically unsaturated monomers, a photoinitiator or a photoinitiator system, a dye and optionally further components.

Elastomeric binders for the production of flexographic printing elements are known to the person skilled in the art. It is possible to use both hydrophilic and hydrophobic binders. Ethylene/acrylic acid copolymers, polyethylene oxide/polyvinyl alcohol graft copolymers, natural rubbers, polybutadiene, polyisoprene, styrene/butadiene rubber, nitrile/butadiene rubber, butyl rubber, styrene/isoprene rubber, polynorbornene rubber or ethylene/propylene/diene rubber (EPDM) may be mentioned as examples. Hydrophobic binders are preferably used. Such binders are soluble or at least swellable in organic solvents whereas they are substantially insoluble in water and are also not swellable or at least not substantially swellable in water.

The elastomer is preferably a thermoplastic elastomeric block copolymer of alkenylaromatics and 1,3-dienes. The block copolymers may be linear, branched or radial block copolymers. Usually, they are three-block copolymers of the A-B-A type, but they may also be two-block polymers of the A-B type, or those having a plurality of alternating elastomeric and thermoplastic blocks, edgy A-B-A-B-A. It is also possible to use mixtures of two or more different block copolymers. Commercial three-block copolymers frequently comprise certain proportions of two-block copolymers. The diene units may be 1,2- or 1,4-linked. It is possible to use block copolymers of both the styrene/butadiene and the styrene/isoprene type. They are commercially available, for example, under the name Kraton®. Thermoplastic elastomeric block copolymers having terminal styrene blocks and a random styrene/butadiene middle block, which are available under the name Styroflex®, can furthermore be used. The block copolymers may also be completely or partly hydrogenated, such as, for example, in SEBS rubbers.

It is of course also possible to use mixtures of a plurality of binders, provided that the properties of the relief-forming layer are not adversely affected thereby. The total amount of binder is usually from 40 to 80% by weight, based on the sum of all components of the relief-forming layer, preferably from 40 to 70% by weight and particularly preferably from 45 to 65% by weight.

The photopolymerizable relief-forming layer furthermore comprises, in a known manner, polymerizable compounds or monomers. The monomers should be compatible with the binders and have at least one polymerizable, ethylenically unsaturated double bond. Esters or amides of acrylic acid or methacrylic acid with mono- or polyfunctional alcohols, amines, amino alcohols or hydroxyethers and hydroxyesters, esters of fumaric or maleic acid or allyl compounds, have proven particularly advantageous, Examples of suitable monomers are butyl acrylate, 2-ethylhexyl acrylate, lauryl acrylate, 1 ,4-butanediol diacrylate, 1,6-hexanediol diacrylate, 1,6-hexanediol dimethacrylate, 1,9nonanediol diacrylate, trimethylolpropane tri(meth)acrylate, dioctyl fumarate and N-dodecylmaleimide. It is of course also possible to use mixtures of a plurality of different monomers. The type and amount of the monomers are chosen by the person skilled in the art according to the desired properties of the layer. The amount of monomer is as a rule not more than 20% by weight, based on the amount of all components.

The photopolymerizable relief-forming layer furthermore comprises, in a manner known in principle, at least one photoinitiator or one photoinitiator system. Examples of suitable initiators are benzoin or benzoin derivatives, such as methylbenzoin, or benzoin ethers, benzil derivatives, such as benzil ketals, acylarylphosphine oxides, acylarylphosphinic esters, polynuclear quinones or benzophenones. The amount of photoinitiator in the relief-forming layer is as a rule from 0.1 to 5% by weight, based on the amount of all components of the relief-forming layer.

The relief-forming layer may optionally comprise a plasticizer. Mixtures of different plasticizers may also be used. Examples of suitable plasticizers comprise modified and unmodified natural oils and natural resins, such as high-boiling paraffinic, naphthenic or aromatic mineral oils, synthetic oligomers or resins, such as oligostyrene, high-boiling esters, oligomeric styrene/butadiene copolymers, oligomeric α-methylstyrene/p-methylstyrene copolymers, liquid oligobutadienes, in particular those having a molecular weight of from 500 to 5000 g/mol, or liquid oligomeric acrylonitrile/butadiene copolymers or oligomeric ethylene/propylene/diene copolymers. Polybutadiene oils rich in vinyl groups, high-boiling aliphatic esters and mineral oils are preferred. High-boiling, substantially paraffinic and/or naphthenic mineral oils are particularly preferred, For example, so-called paraffin-based solvates and special oils under the names Shell Catenex S and Shell Catenex PH are commercially available. In the case of mineral oils, the person skilled in the art distinguishes between technical white oils, which may also have a very low aromatics content, and medical white oils, which are substantially free of aromatics. They are commercially available.

The amount of an optionally present plasticizer is determined by the person skilled in the art according to the desired properties of the layer. However, it should as a rule not exceed 40% by weight, based on the sum of all components of the photopolymerizable relief-forming layer.

According to the invention, the relief-forming layer furthermore comprises at least one dye which has absorption bands in the range from 450 to 1000 nm. The function of the dye is to absorb the radiation used for drying the flexographic printing plate, to such an extent that drying is permitted as rapidly as possible. On the other hand, however, it also should not adversely affect the properties of the relief-forming layer, or at least should not affect them to an unacceptable extent. The dye may be a dye which is soluble in the relief-forming layer, or a dye in pigment form, Dyes which absorb in the visible range of the spectrum are of course more or less strongly colored, and dyes which absorb substantially in the NIR range have as a rule only a weak intrinsic color.

The dye should absorb as little as possible in the range from 300 to 400 nm. As a result, disturbances in the photochemical crosslinking of the layer are avoided. The differentiation factor (DF) of the dye used

$$D F = \frac{\begin{matrix}Maximum value of the absorption \\ in the range from 450 to 1000 nm\end{matrix}}{\begin{matrix}Maximum value of the absorption \\ in the range from 300 to 400 nm\end{matrix}}$$

is, according to the invention, greater than 1, preferably greater than 1.5, particularly preferably greater than 2 and very particularly preferably greater than 3.

Furthermore, the dye should have a sufficient absorptivity. The absorptivity can be determined in a known manner by determining the molar extinction coefficient εₘₒₗ. As a rule, the dye should have at least one absorption band having an extinction coefficient εₘₒₗ of at least 250 l/mol cm in the range from 450 to 1000 nm although the invention is not limited thereto. Preferably, εₘₒₗ is at least 300 l/mol cm, particularly preferably at least 400 l/mol cm and very particularly preferably at least 500 l/mol cm. In the range from 300 to 400 nm, the extinction coefficient should as a rule not be greater than 250 l/mol cm, preferably not greater than 200 l/mol cm.

The dye may have one or more absorption bands in the spectral range from 450 to 1000 nm. Preferably, the dye has only one absorption band in said spectral range.

According to the Invention, the minimum difference between the maximum value of the absorption in the range from 450 to 1000 nm and the maximum value of the absorption in the range from 300 to 400 nm is at least 50 nm, Preferably, the difference between the absorption maxima should be greater. Differences of at least 100 nm, particularly preferably at least 150 nm and, for example, those of from 200 to 350 nm have proven useful.

In a preferred embodiment of the invention, dyes, in particular azo dyes, which have a maximum of the absorption from 450 to 700 nm, preferably from 550 to 650 nm, can particularly advantageously be used.

The type of dye is not important here, provided that it has the DF according to the invention and no negative properties are caused by the addition to the relief-forming layer. Examples comprise conventional NIR dyes, for example cyanines, naphthalocyanines, or NIR dyes based on perylenes. Furthermore, corresponding azo dyes may be used. The person skilled in the art makes an appropriate choice from the dyes possible in principle.

It is of course also possible to use mixtures of two or more such dyes

The amount of the dyes used according to the invention is determined by the person skilled in the art according to the desired properties of the printing plate and according to the absorptivity of the dye.

In the case of dyes having particularly high extinction coefficients, as little as 0.002% by weight can have a clearly noticeable effect. As a rule, the amount used according to the invention is from 0.005 to 2% by weight based on the sum of all components of the layer. The amount is preferably from 0.006 to 1,56% by weight, particularly preferably from 0.008 to 1% by weight, very particularly preferably from 0.01 to 0.75% by weight and, for example, from 0.0125 to 0.125% by weight.

The relief-forming layer may optionally comprise auxiliaries and/or additives, such as, for example, thermal polymerization inhibitors, photochromic additives, filters and antioxidants. The layer may optionally also comprise other dyes to be distinguished from the dyes used according to the invention. The type and amount of further components are determined by the person skilled in the art according to the properties of the layer. As a rule, however, not more than 10% by weight, based on the sum of all components of the layer, preferably not more than 5% by weight, should be used.

The photopolymerizable relief-forming layer may also comprise a plurality of photopolymerizable layers one on top of the other which have the same, virtually the same or different compositions. A multilayer structure has the advantage that the properties of the surface of the printing plate, such as, for example, ink transfer, can be changed without influencing the properties of the printing plate which are typical for flexographic printing, such as, for example, hardness or resilience. Surface properties and layer properties can thus be changed independently of one another in order to achieve an optimum printing copy.

The thickness of the relief-forming layer(s) is determined by the person skilled in the art according to the desired use of the flexographic printing plate and is as a rule from 0.5 to 7 mm, preferably from 0.8 to 6 mm, particularly preferably from 1 to 5.5 mm and, for example, from 2 to 5 mm.

The flexographic printing element may optionally also comprise further layers in addition to the relief-forming layer.

Examples of such layers comprise an elastomeric lower layer comprising a different formulation, which is present between the substrate and the relief-forming layer(s). With such lower layers, the mechanical properties of the flexographic printing plates can be changed without influencing the properties of the actual printing relief layer.

The same purpose is served by so-called resilient substructures which are present below the dimensionally stable substrate of the flexographic printing element, i.e. on that side of the substrate which faces away from the relief-forming layer.

Further examples comprise adhesion-promoting layers which connect the substrate to layers present thereon or connect different layers to one another.

The photopolymerizable flexographic printing element may furthermore have a nontacky release layer which is transparent to light. Such release layers are also known as substrate layers. They make it easier to peel off any protective sheet present before the flexographic printing element is used and thus avoid damage to the relief-forming layer. They furthermore facilitate the placing and removal of the photographic negative for imaging. Release layers are formed by a polymer forming strong films and the additives which, if appropriate, are present therein. Examples of suitable polymers forming strong films are polyamides, completely or partly hydrolyzed polyvinyl acetates or polyethylene oxide/vinyl acetate graft polymers. In general, the release layers are from 0.2 to 25 μm thick, and the thickness is preferably from 2 to 20 μm.

The flexographic printing element used as starting material may optionally also be protected from damage by a protective sheet, for example a PET protective sheet, which is present on the respective uppermost layer of the flexographic printing element, i.e. as a rule on the release layer. If the photosensitive flexographic printing element has a protective sheet, this must be pealed off before the process according to the invention is carried out.

The production of the flexographic printing element according to the invention has no peculiarities at all and can be effected by the methods known in principle to the person skilled in the art, for example by kneading the components and forming the layer by pressing, by means of extrusion and calendering between substrate sheet and cover sheet or by pouring the dissolved components of the layer onto the dimensionally stable substrate.

The flexographic printing element disclosed above is intended for conventional imaging by means of photographic masks. In a further embodiment of the invention, it may be a digitally imageable flexographic printing element. Here, the flexographic printing element has an additional digitally imageable layer. This may be present on the transparent release layer, but the release layer can also be dispensed with when digitally imageable layers are present, so that the digitally imageable layer is present directly on the photopolymerizable layer.

The digitally imageable layer is preferably a layer selected from the group consisting of the IR-ablative layers, inkjet layers or thermographic layers.

IR-ablative layers or masks are opaque to the wavelength of actinic light and usually comprise a film-forming thermally decomposable binder and at least one IR absorber, such as, for example, carbon black. Carbon black also ensures that the layer is opaque. Suitable binders are both binders soluble in organic media, such as, for example, polyamides or nitrocellulose, and binders soluble in an aqueous medium, for example polyvinyl alcohol or polyvinyl alcohol/polyethylene glycol graft copolymers. A mask can be inscribed into the IR-ablative layer by means of an IR laser, i.e. the layer is decomposed and moved in the area where the laser beam is incident on it. Imagewise exposure to actinic light can be effected through the resulting mask. Examples of the imaging of flexographic printing elements using IR-ablative masks are disclosed in EP-A 654 150 or EP-A 1 069 475.

In the case of inkjet layers, a transparent layer inscribable With inkjet inks, for example a gelatin layer, is applied. This can be printed on with opaque links by means of inkjet printers Examples are disclosed in EP-A 1 072 953.

Thermographic layers are transparent layers which comprise substances which become black under the influence of heat. Such layers comprise, for example, a binder and an inorganic or organic silver salt and can be imaged by means of a printer having a thermal printing head. Examples are disclosed in EP-A 1 070 989.

The digitally imageable layers may also be a so-called peel-off layer, as disclosed, for example, in EPA 654 151.

The digitally imageable layers can be cast on the photopolymerizable layer or the release layer in a manner known in principle.

For carrying out the process according to the invention, the flexographic printing element is used as starting material. If the flexographic printing element comprises a protective sheet, this is first peeled off.

In process step (a), the photopolymerizable relief-forming layer is first exposed imagewise by means of actinic radiation.

With the use of flexographic printing elements without a digitally imageable layer, a photographic mask is placed on top for imaging of the relief-forming layer in process step (a). Thereafter, the flexographic printing element is exposed to actinic light through the mask placed on top.

Suitable actinic, i.e. chemically “active” light is known to be, in particular, UVA or UVA/VIS radiation. By means of the exposure to radiation, the photopolymerizable layer is crosslinked in the parts which are not covered. In order to achieve problem-free positioning of the photographic negative, the exposure to light can be carried out in a known manner using a vacuum printing frame or under a glass plate.

If the dimensionally stable substrate Is transparent, the flexographic printing element can optionally be exposed to actinic light from the back in a process step preceding (a). Such a step makes it possible to establish the relief height and contributes toward better anchoring of the relief elements.

When flexographic printing elements comprising digitally imageable layers are used, the process according to the invention is very similar to that described above. Instead of the use of a photographic mask, in process step (a) the digitally imageable layer is imaged by means of the technique required in each case and so to speak a mask is thus produced in situ on the relief-forming layer.

An IR-ablative layer is removed imagewise with the aid of an IR laser. Those parts which are subsequently to be crosslinked are bared and form the relief elements. With the use of inkjet layers or thermographic layers, the digitally imageable layer is printed on by means of inkjet or thermographic printers in those parts which are not to be crosslinked in the course of the exposure to radiation.

After the production of a mask from the digitally imageable layer, exposure by means of actinic light is effected as with the use of a photographic mask. A vacuum printing frame for exposure to light is not required. Exposure to light is preferably effected by means of a flat-bed exposure unit in air.

In process step (b), the flexographic printing element is developed using a suitable washout agent. In this procedure, the unexposed parts of the relief layer, i.e. those pans covered by the mask, are removed, while the exposed, i.e. crosslinked parts remain. The crosslinked pars are not dissolved but nevertheless swell in a washout agent.

The known washout agents for flexographic printing plates, which usually consist of mixtures of different solvents which cooperate in a suitable manner, are particularly suitable for this purpose. Depending on the type of layer, they are organic or aqueous washout agents. Examples of organic washout agents comprise washout agents comprising naphthenic or aromatic mineral oil fractions as a mixture with alcohols, for example benzyl alcohol or cyclohexanol and, if appropriate, further components, such as, for example, alicyclic hydrocarbons, terpene hydrocarbons, substituted benzenes, such as, for example, dilsopropylbenzene, or dipropylene glycol dimethyl ether. Suitable washout agents are disclosed, for example, In EP-A 332 070 or EP-A 433 374.

The washout process can be carried out, for example, in a manner known in principle, by means of a brush washer. However, other apparatuses can of course also be used. The washing out can be carried out at room temperature or at elevated temperatures, for example at temperatures of from 30 to 60° C.

If a digitally imageable flexographic printing element was used, the residues thereof are likewise removed in the washout step. However, it is also possible first to remove the residues of the digitally imageable layer by an upstream step using a different washout agent and only thereafter to develop the relief-forming layer.

In process step (c), the washed-out flexographic printing plate is dried. The drying is effected substantially with radiation in the VIS/NIR range. The term “substantially with radiation in the VIS/NIR range” in the context of this invention is intended to mean that the energy input for drying is to be effected especially with the aid of radiation.

The radiation is absorbed, inter alia, by the added dye. It is of course also possible for other components of the layer to absorb the radiation. As a result, the energy is introduced substantially uniformly in the total relief layer.

In the conventional drying of flexographic printing plates by means of through-circulation driers, the energy input takes place according to completely different mechanisms. The surface of the flexographic printing plate is heated by means of a warm air stream and, if appropriate, supported by long-wave IR radiation. The heat is introduced by dissipation into the total relief layer starting from the surface.

Since the thermal conductivity of polymers is comparatively poor, this process takes a correspondingly long time.

In the present invention, the introduction of a small part of the energy into the layer also by means of dissipation should not be completely ruled out. However, the substantial part should be introduced by radiation in the VIS/NIR range. In a preferred embodiment of the invention, not more than 30% of the energy, particularly preferably not more than 20% of the energy, are introduced by means of dissipation.

The VIS/NIR radiation used for the drying is “cold” radiation, i.e. radiation which comprises only small proportions of long-wave IR radiation. In the context of the invention, radiation in the VIS/NIR range is to be understood as meaning radiation in the range of from 400 to 2500 nm, The person skilled in the art is aware that, owing to the width of the radiation spectra of conventional emitters, certain proportions of the radiation may also be outside said ranges. As a rule, at least 70%, preferably 80%, of the radiation should be emitted in said range. The radiation maximum of the radiation used is as a rule at not more than 1600 nm, preferably at not more than 1300 nm. Preferably, the radiation range is from 450 to 2000 nm, particularly preferably from 500 to 1700 nm.

The limitation to the desired spectral range can be achieved by using appropriate light sources which preferably emit in the desired spectral range. However, it is also possible to use radiation sources having a higher proportion of long-wave IR radiation and to filter out the proportions of long-wave IR radiation from the spectrum with the aid of suitable filters and/or coolants.

In an embodiment of the invention, for example, one or more radiation sources can be installed in a glass tube in which a coolant which is transparent to NIR or VIS radiation additionally circulates.

Emitters having a high proportion of NIR radiation and a radiation maximum In the NIR range are commercially available (e.g. Noblelight® or InfraLight®, from Heraeus). The surface of the emitter is substantially cooler than in the case of conventional emitters. With the aid of cold radiation, the relief layer can be effectively heated, so to speak “from the inside outward”.

In a further embodiment of the invention, however, it is also possible to use emitters which have a radiation maximum in the VIS range, i.e. from 400 nm to 700 nm, preferably from 500 to 700 nm.

A gas stream which need not be heated is expediently used for transporting away the washout agent. A suitable drying unit may consist, for example, of a chamber in which the swollen flexographic printing plate is placed and through which a purge gas stream flows. Suitable radiation sources may be mounted above the relief layer inside the chamber. Of course, other constructions are also possible.

The flexographic printing plate can optionally also be subjected to conventional after treatment steps, such as, for example, elimination of tack by UV-C radiation, after the drying.

By means of the drying process according to the invention, the drying time of even relatively thick flexographic printing plates can be effectively reduced. Even plates having a thickness of about 6 mm can be dried in less than 30 min. As a result, substantially faster processing of print jobs by means of flexographic printing is possible.

The examples which follow are intended to explain the invention in more detail.

Dye used:

An azo dye of the was used for the tests. The structural formula is shown in FIG. 1.

The dye was dissolved in toluene in a concentration of 1 mmol/l. The UV/VIS absorption spectrum was then determined by means of a photometer (cell diameter 1 cm). The absorption spectrum is shown in FIG. 2.

The maximum in the wavelength range of 450-600 nm is at 583 nm, and the absorption here is 0.58 (i.e. εₘₒₗ=580). The maximum in the wavelength range of 300-400 nm is at 308 nm, and the absorption here is 0.17. The differentiation factor DF is thus 3.4.

### EXAMPLES 1 TO 3

A standard test formulation of the following composition was used:

| | | Amount |
|---|---|---|
| Component | Type | [% by wt.] |
| Binder | Oil-extended SBS block copolymer (from | 68.1 − x |
| | 30 to 33% of white oil, M_{w} 170 000 g/mol, | |
| | 31% of polystyrene) | |
| Monomer | Hexanediol diacrylate | 6.5 |
| Plasticizer | Polybutadiene oil | 23 |
| Photoinitiator | BDK | 1.4 |
| Additives | Heat stabilizer, regulator dye | 1 |
| Azo dye | According to formula 1 | x |

Three formulations which in each case differed only in the amount of the azo dye used were employed.
I=No azo dye
II=Concentration of azo dye=0.003%
III=Concentration of azo dye=0.015%

Three printing plates having a thickness of 4.70 mm were produced by extrusion. The extrusion unit used was a twin-screw extruder (ZSK 53, Werner & Pfleiderer), the throughput being 30 kg/h. The calendering was effected between two calender rolls heated to 90*C, the substrate film being passed over the upper calender roll, and the cover element over the lower calender roll.

The raw plates produced were exposed to light in a chessboard pattern and washed out in an F V rotary brush washer (from BASF Drucksysteme GmbH) by means of a conventional organic washout agent for flexographic printing plates (nylosolv A®, BASF Drucksysteme GmbH).

The washed-out flexographic printing plates were then dried.

A conventional flexographic printing plate drier was modified for this purpose. For operation, instead of the air stream used being warmed up in the usual manner, a plurality of commercial NIR emitters having a radiation maximum at about 1000 nm was installed parallel to one another in the drying chamber (Hereaus InfraLight® emitters, length in each case about 60 cm), which emitters heated the flexographic printing plate from above by means of radiation.

The drying speed was determined by measuring the change in layer thickness (measure of redrying) of the plates produced at different times after the beginning of drying.

The results are listed in table 1:

TABLE 1
Change in layer thickness in μm of the plate on washing out
and drying, based on the thickness of the exposed plate.

| | Change in layer thickness [μm] | | |
|---|---|---|---|
| Concentration of dye | 0% | 0.003% | 0.015% |
| Exposed plate | 0 | 0 | 0 |
| Plate after washout | 90 | 90 | 95 |
| 5 min drying time | 80 | 70 | 60 |
| 10 min drying time | 70 | 50 | 40 |
| 15 min drying time | 50 | 40 | 20 |
| 20 min drying time | 35 | 20 | 10 |
| 25 min drying time | 20 | 10 | 0 |
| 30 min drying time | 10 | 0 | 0 |

The results in table 1 clearly show the influence of the added dye. The plate dries all the more rapidly the higher the dye concentration.

1-10. (canceled)

11. A process for producing flexographic printing plates comprising the steps of:
(a) imagewise exposure of the photopolymerizable, relief-forming layer by means of actinic radiation,
(b) washing out of the unpolymerized parts by means of a washout agent,
(c) drying of the washed-out printing plate,
wherein said drying is carried out substantially using radiation in the VIS/NIR range and the differentiation factor (DF) of the dye is greater than 1; wherein
$$D F = \frac{\begin{matrix}Maximum value of the absorption \\ in the range from 450 to 1000 nm\end{matrix}}{\begin{matrix}Maximum value of the absorption \\ in the range from 300 to 400 nm ;\end{matrix}}$$
wherein the starting material used is a photopolymerizable flexographic printing element comprising a dimensionally stable substrate and at least one photopolymerizable, relief-forming layer, said at least one photopolymerizable, relief-forming layer comprising an elastomeric binder, ethylenically unsaturated monomers, photoinitiator, and a dye; and
wherein said dimensionally stable substrate and said at least one photopolymerizable, relief-forming layer are arranged one on top of the other.

12. The process according to claim 11, wherein DF is greater than 2.

13. The process according to claim 11, wherein the amount of said dye is from 0.005 to 2% by weight based on the sum of all components of said at least one photopolymerizable, relief-forming layer.

14. The process according to claim 11, wherein the step (a) is carried out by placing a mask on the flexographic printing element and effecting exposure to light through the positioned mask.

15. The process according to claim 11, wherein the flexographic printing element additionally comprises a digitally imageable layer and step (a) is carried out by inscribing the digitally imageable layer imagewise and exposing it to light through the mask produced thereby.

16. The process according to claim 15, wherein said mask is selected from the group consisting of IR-ablative masks, inkjet masks, and thermographic masks.

17. The process according to claim 11, wherein said dimensionally stable substrate is a film of a polymeric material.

18. A photopolymerizable flexographic printing element comprising a dimensionally stable substrate and at least one photopolymerizable, relief-forming layer, said at least one photopolymerizable, relief-forming layer comprising an elastomeric binder, ethylenically unsaturated monomers, photoinitiator, and a dye; wherein said dimensionally stable substrate and said at least one photopolymerizable, relief-forming layer are arranged one on top of the other; wherein the differentiation factor (DF) of the dye is greater than 1; wherein
$$D F = \frac{\begin{matrix}Maximum value of the absorption \\ in the range from 450 to 1000 nm\end{matrix}}{\begin{matrix}Maximum value of the absorption \\ in the range from 300 to 400 nm ;\end{matrix}}$$
and
wherein the amount of said dye is from 0.005 to 2% by weight based on the sum of all components of said at least one photopolymerizable, relief-forming layer.

19. The photopolymerizable flexographic printing element according to claim 18, wherein DF is greater than 2.

20. The photopolymerizable flexographic printing element according to claim 18, wherein the amount of said dye is from 0.01 to 1% by weight based on the sum of all components of said at least one photopolymerizable, relief-forming layer.
